(19) United States
(12) Patent Application Publication
(10) Pub. No.: US 2007/0227374 A1
(43) Pub. Date: Oct. 4, 2007

(54) Apparatus for the application of a film of dampening solution in printing units of rotary presses

(75) Inventor: Hellmut Funk, Uberlingen (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/800,088

(22) Filed: May 3, 2007

Related U.S. Application Data
(63) Continuation of application No. PCT/DE05/01953, filed on Nov. 2, 2005.

(30) Foreign Application Priority Data
Nov. 3, 2004 (DE) 10 2004 053 059.9

(51) Int. Cl. B41L 25/00

(52) U.S. Cl. 101/147

(57) ABSTRACT

An apparatus for the application of a film of dampening solution in printing units of rotary presses has a hollow dampening solution roll with a porous roll wall. The roll cavity is filled with a liquid under pressure. A membrane is disposed on the inside of the porous roll wall. The membrane has pores that are smaller than the pores of the porous roll wall.

### CROSS-REFERENCE TO RELATED APPLICATIONS

This is a continuing application, under 35 U.S.C. § 120, of copending international application PCT/DE2005/001953, filed Nov. 2, 2005, which designated the United States; this application also claims the priority, under 35 U.S.C. § 119, of German patent application DE 10 2004 053 059.9, filed Nov. 3, 2004; the prior applications are herewith incorporated by reference in their entirety.

### BACKGROUND OF THE INVENTION

1. Field of the Invention

The invention lies in the printing technology field. More specifically, the present invention relates to an apparatus for the application of a film of dampening solution in printing units of rotary presses. The apparatus includes a hollow dampening solution applicator roll with a porous roll wall and a roll cavity filled with a liquid under pressure.

An apparatus of the general type is described, by way of example, in Japanese patent publication JP 05084893 A.

The Japanese document JP 05084893 A discloses hollow rolls with a porous roll wall as an ink or water reservoir, in order to move liquids outward out of the roll cavity through the porous roll wall as an application of dampening solution on the roll outer surface.

FIG. 3 shows a diagram of another known apparatus 100 for the application of a film of dampening solution. The apparatus 100 includes a dampening solution fountain 101, a dampening solution applicator roll (dampening solution ductor) 102 and a dip roll 103, in order to feed the dampening solution applicator roll 102 with dampening solution from the dampening solution fountain 101. The dampening solution circulates continuously in a loop in a line system 104 and, in the process, is provided with dampening solution additives via a dampening solution metering system 105, is cooled by means of a cooling system 106 and is admixed with alcohol for still further wetting. The cooling is needed primarily to reduce the evaporation of the alcohol and other volatile substances. During this process cycle, the circulating dampening solution becomes continually enriched with powder, ink and paper particles 30. After a certain amount of time, this leads to the dampening solution having to be replaced, since bacteria and algae form in the dampening solution, which no longer ensure the functionality of the dampening solution.

### BRIEF SUMMARY OF THE INVENTION

It is accordingly an object of the invention to provide an apparatus for applying a dampening solution film in printing units of a rotary printing press which overcomes the above-mentioned disadvantages of the heretofore-known devices and methods of this general type and which is improved to the effect that a large area film of dampening solution is achieved with as little dampening solution additive (wetting additive/IPA) as possible.

With the foregoing and other objects in view there is provided, in accordance with the invention, an apparatus for applying a film of dampening solution in a printing unit of a rotary press. The apparatus comprises:
a hollow dampening solution applicator roll formed with a porous roll wall and a roll cavity;
a liquid under pressure in the roll cavity; and
a membrane inside the porous roll wall, the membrane having pores formed therein smaller than the pores formed in the porous roll wall.

In other words, the objects are achieved, in accordance with the invention, in that, on the inside of the porous roll wall, there is provided a membrane whose pores are smaller than the pores of the porous roll wall.

The roll wall with its large pores serves as a support for the fine-pore membrane. According to the invention, the mechanical stability of the dampening solution applicator roll is achieved by the roll wall and the filter characteristic by the thinner membrane which, on account of its low wall thickness, nevertheless permits a sufficiently high throughput. By means of the choice of the membrane of the dampening solution applicator roll, the dampening solution can be discharged outward in a finely metered manner. As a result of the direct input of dampening solution into the printing unit, the dampening solution does not have to be moved continually in a loop, which means that there is no soiling of the dampening solution. At the same time, the expenditure in the technical plant construction is substantially lower. As a result of the most recent findings in alcohol free printing, it has been decided that the dampening solution with which printing is carried out in an alcohol free manner should be very pure. Precisely this effect is given in the case of the dampening solution applicator roll since, depending on the choice of the membrane of the dampening solution applicator roll, the solution is additionally purified. According to the invention, dampening solution ductor and dip roll, as were used previously, are replaced by the dampening solution applicator roll with a membrane on the inside, cooling of the dampening solution no longer being required.

The pores of the membrane are preferably smaller than about 0.5 μm and particularly preferably smaller than 0.1 μm, preferably smaller than 0.05 μm. The pore size of the porous roll wall is preferably at least about 0.5 μm and particularly preferably lies between 0.5 μm and 5 μm.

In an advantageous embodiment of the invention, the dampening solution applicator roll is made of porous sintered material, preferably of porous sintered metal, and the diaphragm is a plastic membrane, glass membrane, ceramic membrane, metal membrane or a polymer membrane.

The dampening solution applicator roll preferably has a drain leading out of the roll cavity, which is either permanently open or else can be controlled open or shut.

Further advantages of the invention emerge from the description and the drawing. Likewise, the features mentioned above and those listed still further on can each be used on their own or in a plurality in any desired combinations.

In other words, although the invention is illustrated and described herein as embodied in apparatus for the application of a film of dampening solution in printing units of rotary presses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic illustration of the apparatus according to the invention for the application of a film of dampening solution in a printing unit of a rotary press;

FIG. 2 is a sectional view of the dampening solution applicator roll shown in FIG. 1; and

FIG. 3 is a diagrammatic view of a prior art apparatus for the application of a film of dampening solution.

### DESCRIPTION OF THE PREFERRED EMBODIMENTS

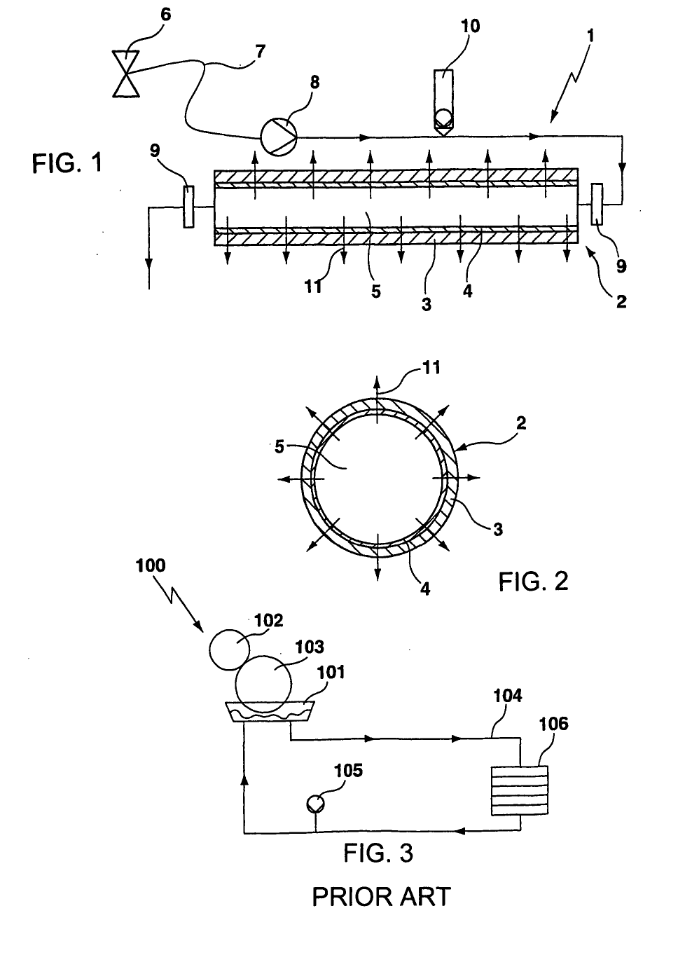

Referring now to the figures of the drawing in detail and first, particularly, to FIG. 1 there, the apparatus 1 for the application of a film of dampening solution in printing units of rotary presses has a hollow dampening solution applicator roll 2 with a porous roll wall 3, on the inside of which a membrane 4 is provided. In the exemplary embodiment, the membrane 4 is a plastic membrane made of polysulfone with a wall thickness of 0.8 mm and a pore size of about 0.3 μm. The dampening solution applicator roll 2 is made of a highly porous sintered material of 1.4404 stainless steel with a wall thickness of 8 mm and with a pore size of 0.5 μm.

A central roll cavity 5 is connected to a freshwater connection 6 via a feed line 7 having a pressure and bypass pump 8, which controls the quantity and the pressure of the fresh water supplied. The bypass needed from time to time is controlled via two control slides 9 arranged upstream and downstream of the dampening solution applicator roll 2. A metering pump 10 meters the dampening solution needed for printing to the freshwater for this purpose. The control slide (drain) 9 controlling the liquid discharge from the roll cavity 5 is either permanently open or can be controlled open and shut.

The dampening solution mixture emerges radially outward from the roll cavity 5 through the pores of the membrane 4 and the roll wall 3, as indicated by the flow arrows 11. The dampening solution applicator roll 2 transfers the dampening solution mixture directly to the plate cylinder or into the printing inking unit (depending on the desired configuration). The mechanical stability of the dampening solution applicator roll 2 is achieved by the roll wall 3, and its filter characteristic by the thinner membrane 4 which, on account of its low wall thickness, nevertheless permits a sufficiently high throughput of the dampening solution mixture. By suitably choosing the membrane 4 of the dampening solution applicator roll 2, the dampening solution can be discharged outward in a finely metered manner. As a result of the direct input of dampening solution into the printing unit, the dampening solution does not have to be moved continually in a loop, which means that there is no soiling of the dampening solution. At the same time, the expenditure in the technical plant construction is substantially lower. The dampening solution, with which printing is carried out without alcohol, should be very pure, which is achieved with the dampening solution applicator roll 2 since, depending on the choice of the membrane 4, the solution is additionally purified. Even if alcohol should be needed for printing, the input with the dampening solution applicator roll 2 has the advantage that the alcohol does not have to be cooled and, as a result of the direct input, barely evaporates and, in this way, permits maximum wetting with extremely low quantities and barely generates emissions.

1. An apparatus for applying a film of dampening solution in a printing unit of a rotary press, comprising:
a hollow dampening solution roll formed with a porous roll wall and a roll cavity;
a liquid under pressure in said roll cavity; and
a membrane inside said porous roll wall, said membrane having pores formed therein smaller than pores formed in said porous roll wall.

2. The apparatus according to claim 1, wherein said pores in said membrane are smaller than substantially 0.5 μm.

3. The apparatus according to claim 2, wherein said pores in said membrane are smaller than 0.1 μm.

4. The apparatus according to claim 2, wherein said pores in said membrane are smaller than 0.05 μm.

5. The apparatus according to claim 1, wherein said membrane is a membrane formed of a material selected from the group consisting of plastic, glass, ceramic, metal, and a polymer.

6. The apparatus according to claim 1, wherein said dampening roll is made of porous sintered material.

7. The apparatus according to claim 6, wherein said porous sintered material is porous sintered metal.

8. The apparatus according to claim 1, wherein said porous roll wall is formed with pores having a pore size of at least about 0.5 μm.

9. The apparatus according to claim 8, wherein said pore size of said pores in said porous roll wall ranges between 0.5 μm and 5 μm.

10. The apparatus according to claim 1, wherein said dampening solution roll is formed with a drain leading out of said roll cavity.

11. The apparatus according to claim 10, wherein said drain is permanently open.

12. The apparatus according to claim 10, wherein said drain is configured to be controlled open and shut.
